(19) United States
(12) Patent Application Publication
(10) Pub. No.: US 2026/0115893 A1
(43) Pub. Date: Apr. 30, 2026

(54) Automated Robotic Device for Coating Application

(71) Applicants: PETRÓLEO BRASILEIRO S.A. - PETROBRAS, Rio de Janeiro (BR); SERVIÇO NACIONAL DE APRENDIZAGEM INDUSTRIAL - SENAI/SC, Florianópolis (BR)

(72) Inventors: Paulo Henrique Giusti, Rio de Janeiro (BR); Ismael José Secco, Joinville (BR); Doglas Negri, Joinville (BR); Thiago Moser, Joinville (BR); Diego de Souza, Joinville (BR); Joel Ribeiro, Joinville (BR); Jonas Greschuk, Joinville (BR); Valéria Farias da Luz, Joinville (BR); Luís Gonzaga Trabasso, Joinville (BR); Clayton Eduardo Rodrigues, São José dos Campos (BR); Brenno Henrique Ramos Domingues, Joinville (BR); Giuliano Ito de Oliveira, Joinville (BR); Gustavo Trevissoi Eberspacher, Joinville (BR); Andre Koebsch, Rio de Janeiro (BR); Ricardo Compiani Tavares, São José dos Campos (BR)

(73) Assignees: PETRÓLEO BRASILEIRO S.A. - PETROBRAS, Rio de Janeiro (BR); SERVIÇO NACIONAL DE APRENDIZAGEM INDUSTRIAL - SENAI/SC, Florianópolis (BR)

(21) Appl. No.: 19/372,549

(22) Filed: Oct. 29, 2025

(30) Foreign Application Priority Data
Oct. 29, 2024 (BR) 1020240225015

(51) Int. Cl. B25J 5/00; B25J 9/10; B25J 11/00; B60B 19/00; B60B 19/12; B62D 55/02

(52) U.S. Cl. CPC B25J 5/007; B25J 5/005; B25J 9/104; B25J 11/0075; B60B 19/003; B60B 19/12; B62D 55/02

(57) ABSTRACT

An automated robotic device for coating application comprising an anchoring robot having magnetic tracks, a winding system and an electrical panel, an end effector robot with a set of active omnidirectional wheels, a set of passive omnidirectional wheels, an oscillator system with linear motor and an anchoring point, in which the oscillator system with linear motor moves a tool for applying the coating and a coupling between the anchoring robot and the end effector robot.

### CROSS-REFERENCE TO RELATED APPLICATIONS

This application claims priority to Brazilian Application No. BR1020240225015 filed on Oct. 29, 2024, the disclosure of which is expressly incorporated herein by reference in its entirety.

### TECHNICAL FIELD

The present invention relates to the field of painting and coating of curved, vertical metal surfaces and cylindrical storage tanks used for oil refining. Specifically, the present invention is directed to painting and applying coatings in an automated manner by means of robots.

### BACKGROUND OF THE INVENTION

In the current state of the art, painting tanks for refining requires the use of scaffolding or work platforms at height, enabling the appropriate positioning of the operator, who will paint the surface using manual spray guns or paint rollers. This procedure exposes employees to unhealthy and dangerous situations due to working at height, varied climatic conditions and substances that are harmful to health, such as paint, petroleum and its derivatives.

Using an automated system, such as a robotic system, to perform the procedure in question is quite advantageous, since it reduces the exposure of operators to work risks. Instead of exposing themselves to risk, they would be responsible for operating and supervising the robot while performing the task. Additionally, productivity, accuracy and precision of operations would be increased.

In order to automate the vertical surface coating procedure, it is necessary to overcome the challenges inherent in the adhesion and displacement of a robotic mechanism to a vertical surface, as well as the configuration of said mechanism, aiming at the adequate positioning of the tool that will perform the coating.

In addition to the variables associated with the tool positioning mechanism and the adhesion and displacement of the robot, there is also the challenge of reproducing the painting performed by the employee. The painting movement performed by the operator is generally done in a rectilinear manner, that is, either in the vertical or horizontal direction. When reaching the ends of a surface, the application of the coating is stopped in order to avoid excess thickness of the painting system, given that the speed during the inversion of the movement is reduced until it equals zero. The application of the coating is resumed after the mechanism reaches its constant application speed.

The document BR 102018077363-1 shows an invention entitled “Robô de cabos” (Cable Robot), which aims to paint large vertical walls, consisting of a system composed of a mobile platform, equipped with mecanum-type wheels with a magnetic base. These components enable both omnidirectional movement and magnetic adhesion, respectively. The platform is suspended with the help of two adapted cranes and with the use of four cables, each of which is connected to a winder and a pivot on the mobile platform. Furthermore, these cables are responsible for moving the platform along the vertical wall. The painting process is carried out using an oscillating mechanism, which is described in the document BR 102018077376-3, where the invention entitled “Plataforma móvel e mecanismo oscilador aplicado ao processo de revestimentos em superficies planas” (Mobile platform and oscillating mechanism applied to the coating process on flat surfaces) is shown. This mechanism consists of a connecting rod and crank type system, to which the paint gun is attached.

The document BR 102022000551-6 shows the invention entitled “Robô com spatas magnéticas aplicado ao processo de revestimento de superficies metálicas” (Robot with magnetic shoes applied to the metal surface coating process), also known as “Difficult to Access Robot”, which was developed to meet the need for painting and coating in difficult to access regions, such as curved, convex and vertical surfaces, on offshore platforms and ships. The system consists of a mobile robot with magnetic shoes to ensure adhesion to the vertical metal surface, and with mecanum-type wheels to provide omnidirectional movement. To apply the coating, a two-degree-of-freedom robotic manipulator coupled to the mobile robot is used, the purpose of which is to position and move the tool.

The document US2013140801 A1 discloses a mobile robot configured to be widely versatile in its use, being usable on a wide variety of surfaces, regardless of the orientation and/or shape of said surfaces. The robot may be configured with two or more component units. In some embodiments, the component units are configured with magnets and a control system for orienting the magnets. In other embodiments, one or more component couplings join the component units. Additionally, it is still possible for the robot to be configured with mecanum wheels.

The document CN 107600214 B discloses a wall-climbing robot, suitable for moving on walls with variable curvature and with the ability to carry different types of operating modules according to different task requirements and perform actions on the surface of several magnetic structures that have curvatures. The robot adopts the combination of permanent magnetic adsorption and track structure to perform its movement.

The document CN 107128389 B discloses a self-adapting magnetic adsorption wall painting robot for curved surface, including four permanent magnetic adsorption track wheel modules, a chassis module, a robotic arm module and a spraying module, which is installed in the upper part of the robotic arm module.

As can be seen, the documents from the state of the art disclose the use of robots with omnidirectional wheels or robots fixed to suspended platforms, however, the prior art solutions do not allow access to remote or difficult-to-access areas, in particular in difficult-to-access areas such as curved surfaces of ships and/or offshore platforms.

Thus, based on the previous inventions and the application of coatings on tanks or metal surfaces, the need to develop equipment capable of performing the task in question in a precise, efficient and safe manner is verified. With this, an invention with the specific and necessary characteristics for this purpose is proposed.

### OBJECTIVES

The objective of the present invention is to provide a robotic device capable of performing the task of applying coatings on metal surfaces, more specifically on curved or difficult-to-access surfaces.

### SUMMARY OF THE INVENTION

The present invention relates to an automated robotic device for applying coatings comprising an anchoring robot, which also comprises magnetic tracks, a winding system and an electrical panel; an end effector robot, comprising a set of active omnidirectional wheels, a set of passive omnidirectional wheels, an oscillator system with a linear motor and an anchoring point, wherein the oscillator system with a linear motor moves a tool for applying the coating and a coupling between the anchoring robot and the end effector robot.

In one embodiment of the present invention, an automated robotic device is used for applying a coating to metal surfaces, which automated robotic device comprises two robotic mechanisms coupled by a cable.

One of the robotic mechanisms has magnetic tracks to ensure adhesion to the metal surface of the tanks, and a coupled winding system, the purpose of which is to wind a cable that is coupled to another robot. Thus, this mechanism has the function of acting as an anchoring robot.

The other robotic mechanism has wheels that have two degrees of freedom, that is, there is the possibility of movement both vertically and horizontally, characterizing an omnidirectional movement. While the vertical movement is performed by means of the coiling of the cable by the anchoring robot, the horizontal movement is performed by means of the actuation of the wheels of the effector robot itself. In addition, there is a linear motor coupled to this robot, the purpose of which is to perform the movement of the coating application tool. Thus, this second mechanism has the purpose of acting as a final effector robot in the coating application procedure.

The end effector robot will be in constant movement, that is, the coating application will be performed both when the robot is being raised and when it is being lowered.

After the application of the coating is completed in a given lane, regardless of the end at which this occurs, the robots will move to the side lane, by means of the actuation of the motors contained in the magnetic tracks, in the case of the anchoring robot, and in the omnidirectional wheels, in the case of the end effector robot, and the coating application process will be repeated.

### BRIEF DESCRIPTION OF THE FIGURES

The present invention will be better understood from the detailed description and the figures described below that refer to it.

FIG. 1a is a view of the automated robotic device positioned on the vertical surface of a tank.

FIG. 1b is a perspective view of the automated robotic device comprising the anchoring robot and the end effector robot.

FIG. 2 is a perspective view of the anchoring robot.

FIG. 3 is a perspective view of the winder present in the anchoring robot.

FIG. 4a is a perspective view of the end effector robot.

FIG. 4b is another perspective view of the end effector robot.

FIG. 5 is a perspective view of the active omnidirectional wheel assembly.

FIG. 6 is a perspective view of the passive omnidirectional wheel assembly.

### DETAILED DESCRIPTION OF THE INVENTION

The present invention relates to an automated robotic device for applying coatings to metal surfaces, which robotic device comprises an anchoring robot, an end effector robot and a coupling between the anchoring robot and the end effector robot.

The following description constitutes only a preferred embodiment within the scope of the present invention.

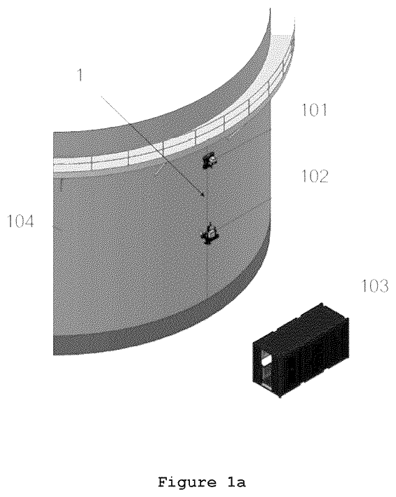

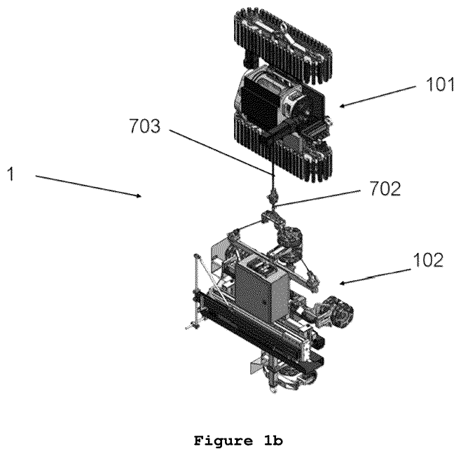

FIG. 1a shows an embodiment of an automated robotic device 1 for applying coating to metal surfaces of storage tanks 104, which includes the anchoring robot 101 and the end effector robot 102, wherein the anchoring robot 101 and the end effector robot 102 are coupled to each other by means of a cable and fixed to the metal surface of a storage tank 104. Additionally, FIG. 1a illustrates the presence of a control room 103 for providing instructions to the automated robotic device 1 for applying coating.

In other embodiments, the control room 103 may be represented by a control panel, a console, remote control systems or any means that allows remote control of the automated robotic device 1 for applying coating by an operator.

FIG. 1b shows in detail the assembly configuration of the automated robotic device 1 for coating application, which comprises the anchoring robot 101, connected by a cable 703 to the end effector robot 102 through an anchoring point 702.

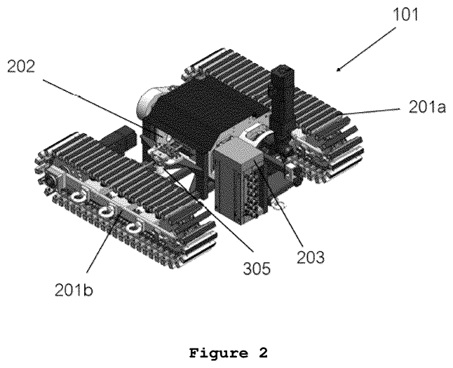

FIG. 2 shows in detail the anchoring robot 101, which comprises magnetic tracks 201a, 201b to ensure adhesion to the metal surface, a winding system 202, which is responsible for controlling the cable coupled to the end effector robot 102 and an electrical panel 203 containing the equipment necessary to drive the set of magnetic tracks 201a, 201b of the winding system 202 and establish communication with the control room 103. Additionally, it is possible to note the presence of a sensor 305.

The set of magnetic tracks 201a, 201b has permanent magnets, whose configuration generates a magnetic force of attraction between the anchoring robot 101 and the metal surface, in addition to generating a friction force necessary to enable the movement of the anchoring robot 101 on the metal surface.

The winding system 202 is a mechanism that ensures the winding of the cable 703, which ensures the vertical movement of the end effector robot 102. The electrical panel 203 is a closed electrical control panel for the set of magnetic tracks 201a, 201b and for the winding system 202, in addition to being where the electrical power, communication and sensing equipment will be mounted. This composition allows the automatic change in the winding direction of the cable 703 and the verification of the alignment between the anchoring robot 101 and the end effector robot 102.

Briefly, the anchoring robot 101 has the function of anchoring the end effector robot 102, by means of the winding of a cable 703, which couples both the anchoring robot 101 and the end effector robot 102.

The anchoring robot 101 is capable of moving in a single direction and of rotating in the plane. Thus, to climb a surface, the anchoring robot 101 is positioned so that it can perform the movement vertically. Upon reaching the desired height, the anchoring robot 101 is rotated 90 degrees, enabling horizontal movement.

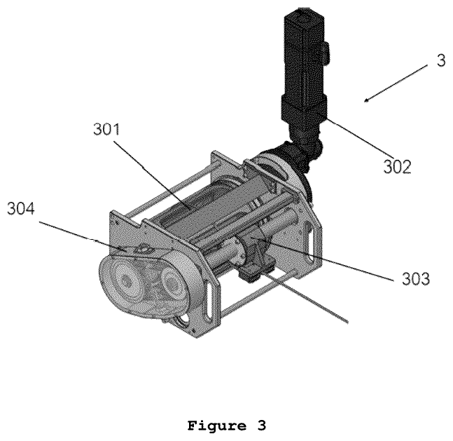

FIG. 3 shows in detail the mechanism of the winding system 202, where there is the presence of a winding drum 301, a reduction motor assembly 302, a cable steering system 303, a transmission system 304 and a sensor 305 (not shown), the purpose of which is to measure the angulation of the cable 703.

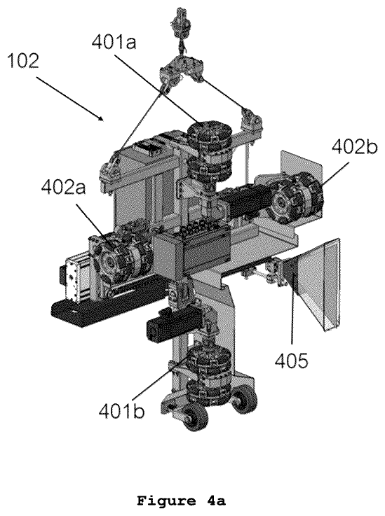

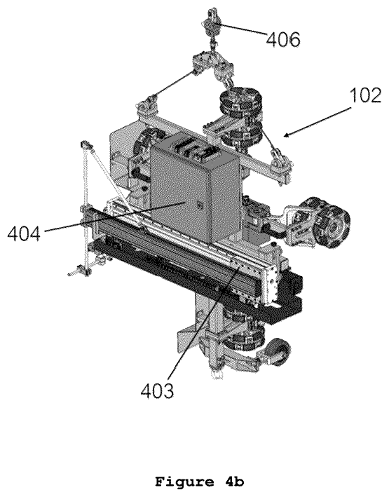

FIGS. 4a and 4b show in detail the end effector robot 102. The end effector robot 102 has two sets of omnidirectional wheels 401a, 401b, 402a, 402b, one set of active omnidirectional wheels 401a, 401b and one set of passive omnidirectional wheels 402a, 402b.

FIG. 4b illustrates an anchoring point 406, i.e. the location where the cable 703 from the anchoring robot 101 is coupled. Additionally, there is a linear motor 403, the function of which is to move the tool 405 that will perform the application of the coating.

The tool 405 is the representation of a painting device, such as a paint gun or other device for applying a coating.

FIG. 4b also indicates the presence of an electrical panel 404, which is necessary to enable the electrical actuation of the linear motor 403, of the set of active omnidirectional wheels 401a, 401b, of the set of passive omnidirectional wheels 402a, 402b and also to establish communication with the control room 103.

The linear motor 403 is responsible for moving the tool 405. The procedure performed consists of activating the linear motor 403, which, after reaching a constant speed, activates the tool 405 to perform the application of the coating. Upon reaching one end of the surface to which the coating is being applied, the tool 405 stops operating, and then the linear motor 403 has its speed reduced until it is zero. This execution sequence is performed in order to ensure that there will be no excess thickness of the coating application at times when the linear motor 403 is at variable speed.

The end effector robot 102 moves vertically by means of the traction of the cable 703, while the horizontal movement is made possible by the actuation of the set of active omnidirectional wheels 401a, 401b. The viability of these movements is due to the configuration of the set of active omnidirectional wheels 401a, 401b and the set of passive omnidirectional wheels 402a, 402b, which have an electric motor 403 and rollers 505, 602 whose rotation movement around their own axis is free.

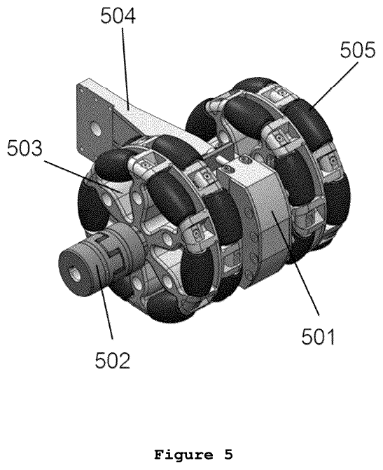

FIG. 5 shows in detail the configuration of the set of active omnidirectional wheels 401a, 401b. This mechanism consists of a set of magnetic shoes 501, which are present in order to ensure that there will be no slipping of the end effector robot 102, by means of magnetic adhesion to the metal surface, and by a set of rollers 505, 602 whose rotation movement around their own axis is free.

Additionally, the active omnidirectional wheel assembly 401a, 401b shows, in detail, the presence of a coupling 502 for a motor, a wheel assembly 503 and a bearing 504, in which the roller set 505 is fixed to the structure of the wheel assembly 503.

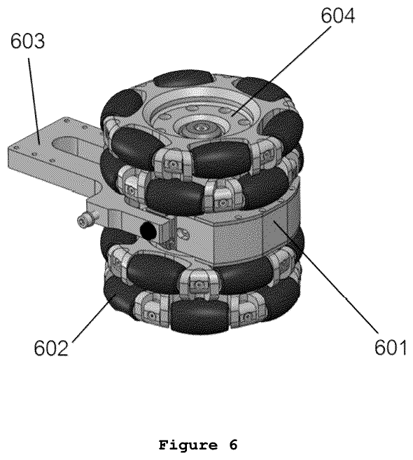

FIG. 6 shows in detail the configuration of the passive omnidirectional wheel assembly 402a, 402b. Similar to the active omnidirectional wheel assembly 401a, 401b, the passive omnidirectional wheel assembly 402a, 402b has a magnetic shoe assembly 601 and a roller assembly 602.

Additionally, the passive omnidirectional wheel assembly 402a, 402b shows, in detail, the presence of a wheel assembly 604 and a bearing 603, in which the roller assembly 602 is fixed to the structure of the wheel assembly 604.

What is claimed is:

1. An automated robotic device for coating application comprising:
an anchoring robot comprising a set of magnetic tracks, a winding system and an electrical panel;
an end effector robot, comprising a set of active omnidirectional wheels, a set of passive omnidirectional wheels, an oscillator system with linear motor and an anchoring point,
wherein the oscillator system with linear motor moves a tool to apply the coating; and
a coupling between the anchoring robot and the end effector robot.

2. An automated robotic device according to claim 1, wherein the winding system of the anchoring robot comprises a winding drum, a reduction motor assembly, a cable routing system, a transmission system and a cable angulation measurement sensor.

3. An automated robotic device, according to claim 1, wherein the set of active omnidirectional wheels further comprises:
a set of magnetic shoes;
a coupling for a motor;
a set of wheels; and
a bearing and a set of rollers;
wherein the set of rollers is fixed to the structure of the set of wheels.

4. An automated robotic device according to claim 3, wherein the set of passive omnidirectional wheels further comprises:
a set of magnetic shoes;
a set of rollers;
a bearing; and
a set of wheels;
wherein the set of rollers is fixed to the structure of the set of wheels.

5. An automated robotic device according to claim 1, wherein the coupling between the anchoring robot and the end effector robot is carried out by means of a cable.

6. An automated robotic device according to claim 5, wherein the cable is wound by the winding system and coupled to an anchoring point.

7. An automated robotic device according to claim 1, wherein vertical movement of the end effector robot is performed by means of the winding of the cable by the anchoring robot; and
horizontal movement of the end effector robot is performed by means of the actuation of the set of active omnidirectional wheels and the set of passive omnidirectional wheels of the end effector robot.

8. An automated robotic device according to claim 1, wherein the tool comprises a paint and/or coating application device.
